(19) United States
(12) Patent Application Publication
(10) Pub. No.: US 2018/0073233 A1
(43) Pub. Date: Mar. 15, 2018

(54) BODY CLEANER FOR CLOSESTOOL

(71) Applicant: Hongwen LIU, Guangdong (CN)

(72) Inventor: Hongwen LIU, Guangdong (CN)

(21) Appl. No.: 15/531,447

(22) PCT Filed: Nov. 27, 2015
(86) PCT No.: PCT/CN2015/095802

§ 371 Date: Jun. 29, 2017

(30) Foreign Application Priority Data
Nov. 27, 2014 (CN) 201420732216.2
Mar. 10, 2015 (CN) 201520135602.8
Mar. 10, 2015 (CN) 201520135604.7
Mar. 10, 2015 (CN) 201520136462.6
Mar. 17, 2015 (CN) 201520153250.9

(51) Int. Cl. E03D 9/08; A47K 10/48; B05B 15/08

(52) U.S. Cl. CPC E03D 9/08; B05B 15/08; A47K 10/48

(57) ABSTRACT

Disclosed is a body cleaner for a closestool, comprising water spray devices having a body cleaning function, fixing devices for fixing the water spray devices, and silicone hoses for providing a water flow, wherein water inlet ends of the silicone hoses are connected to a tap water pipe, and water outlet ends thereof are connected to the water spray devices; the fixing devices are arranged on the rear end of an opening of the closestool and fixed on the inner wall of the opening of the closestool; the height of the water outlet ends of the silicone hoses in the vertical direction can be adjusted; and the water spraying devices are provided with at least one nozzle which inclines upwards to form a 45-degree angle, and the nozzle is properly aligned with the front upper end of the opening of the closestool.

### TECHNICAL FIELD

This invention relates to technical field of living supplies, especially a kind of toilet bidet.

### BACKGROUND ART

Toilet is a life utensil very familiar to people. People will clean anus or vulva after toilet. The common means is to wipe with toilet paper, but this method cannot clean thoroughly, and wastes a large amount of paper. At present, there are many toilets with bidet in the market. Bidet generally consists of electronic bidet and mechanical bidet, with complex structure and high cost. Toilet cover of some toilets has to be removed.

Generally, water spray device is fixed and mounted on interior wall at the top of toilet stand. This structure will occupy plenty of space, and is easily polluted during use. When bidet is mounted, original toilet cover of some toilets often needs to be removed, which wastes time and energy, results in a waste of resources and is not environment-friendly.

In addition, toilets have different shapes and sizes, so dimensions of bidet need to be checked before installation, with limited applicability. When bidet has failure rate, it will not be easily replaced and maintained, and need to be repaired by the professional maintenance personnel, which causing inconvenience for users. As a result, it cannot meet requirements of the wide public.

### CONTENT OF THE INVENTION

Specific to the aforesaid disadvantages, this invention provides a kind of toilet bidet with simple structure, low cost, convenient maintenance, and wide applicability as well as not taking up extra space.

For this reason, toilet bidet of this invention consists of water spray device, fixing device for fixing water spray device, and silicone hose providing water. The water inlet end of silicone hose is connected to tap water pipe, and the water outlet end is connected to water spray device. Fixing device is arranged on rear end of toilet opening and fixed on interior wall of the toilet opening. The junctions between water outlet end of silicone hose and water spray device are movably clamped inside the fixing devices actively so as to make the height of water outlet end of silicone hose adjustable in vertical direction. Water spray devices are provided with at least one nozzle which inclines upwards to form a 45-degree angle, and the nozzle is properly aligned with the front upper end of toilet opening.

The nozzle consists of a shell, a rotor and a nozzle tube. The shell consists of a cavity in which a inserted tube connected with silicone hose is fixed, and an opening is installed on the front of the lower section of the shell longitudinally and the cavity is provided with a concave cavity on the top of opening; the said rotor is installed in the concave cavity and matches with it, and a limber hole is arranged on the rotor towards the direction of inserted tube; the said nozzle tube and the rotor are integrated to a whole; the nozzle tube is connected with limber hole and the nozzle tube can be rotated up and down along the opening.

The nozzle consists of a tubular shell which is installed in the mounting base, a nozzle tube which is installed in the shell and moves up and down in the shell and a spring which is covered outside the nozzle tube; resistance part is installed at the bottom of the shell and the top of outer wall of the nozzle tube; both side of the spring are butted on the resistance parts of the shell and the nozzle tube separately, and a limber hole is installed on the lower section of the nozzle tube.

The fixing device consists of a base, a semicircular groove, a semicircular iron block, a round magnet and a round sleeve with both inside and outside layers; a magnet placing slot is installed between both inside and outside layers of the round sleeve which is fixed in the magnet placing slot; the semicircular groove is installed at the base and back to the base with the slot opening, and the semicircular iron block is fixed in the semicircular groove with adhesive film; the round sleeve is covered movably outside the silicone hose; when the round sleeve fixed with round magnet approaches to the semicircular iron block, the semicircular iron block and the round magnet attract each other to make the silicone hose fixed on the fixing device.

The bidet also consists of at least one secondary fixing seat which is used to fix the silicone hose and is fixed between the water inlet end of silicone hose and the fixing device; the secondary fixing seat consists of one base and two clasps which are laid side by side on the upper end face of the base, and two clasps are installed in a reversed direction to make the open end of two clasps in a reversed direction.

The fixing device consists of the primary connecting plate which is fixed at the bottom of the toilet seat with adhesive film and the secondary connecting plate which is against with the toilet opening inner wall closely and in a vertical state when the toilet seat is down; the primary connecting plate is articulated with the secondary connecting plate; the water spray device which consists of mounting base and silicone hose are fixed on the secondary connecting plate; the nozzle is fixed in the mounting base, and there is magnetic attraction between the mounting base and the secondary connecting plate.

The fixing device consists of two mounting block and one mounting plate clamped on mounting block. Mounting plate consists of one shell with at least one holding tank, cover plate clamped on the shell, at least one inserted tube arranged on one end of the shell for connecting water inlet pipe; inserted tube is connected to holding tank; the long side of the shell is provided with an extension part for mounting water spray device at horizontal extension; the holding tank is arranged on extension part; both sides of the mounting block are provided with interior wall for clamping mounting plate.

The silicone hose consists of water inlet pipe and water outlet tube. The water inlet end of the water inlet pipe is connected to the tap water pipe and the water outlet end is connected to the water tank heating device with water temperature regulator. The water outlet end of water tank heating device is connected to the water inlet end of the water outlet pipe. The water outlet end of the water outlet pipe is connected to the sprayer; Water temperature regulator consists of a microprocessor and wireless transceiver module connected to the microprocessor signal. Wireless transceiver module is connected to the remote control for regulating and controlling the water temperature regulator by wireless.

The bidet also consists of a control device for controlling water temperature and water-yield capacity. The control device consists of the primary pressure regulating valve installed on the side of the toilet for regulating the cold water and the secondary pressure regulating valve for regulating the warm water and the water yield controller for controlling the inlet water capacity which is installed of the water tank of the toilet and connected to the water inlet end of the silicone hose. The primary pressure regulating valve and the secondary pressure regulating valve are connected to the inlet hole of Y-shaped tee. The outlet hole of Y-shaped tee is connected to the water yield controller. The primary pressure regulating valve is connected to the tap water pipe and the secondary pressure regulating valve is connected to the water outlet end of water tank heating device.

The bidet also consists of an air blast dryer. The air blast dryer is arranged inside the water tank device and it is connected to an air outlet. The air outlet is connected to the water outlet pipe. The exterior surface of air blast dryer is provided with wind-heat adjusting key for regulating wind-heat.

Beneficial effects of this invention are as follows:

Compared with existing technologies, toilet bidet of this invention is characterized with small accessories, simple installation and convenient application. It only requires the connection of two ends of silicone hose respectively to the tap water pipe and the water spray device, and then disassembled fixation of fixing device on interior wall of toilet opening at proper position and the arrangement of the sprayer on the front side of the fixing device, so as to conveniently wash the human perineum, which can save toilet paper, and is very environment-friendly. It only requires a few minutes to install, which is very convenient, and it is convenient to use, especially for children and elderly people with limited mobility. What's more, water spray device in this invention also can be taken from fixing device at any time and used to wash floor, sole, vegetables, and stubborn stain in the toilet without disassembling any parts and any tools.

### BRIEF DESCRIPTION OF THE DRAWINGS

FIG. 1 is the overall structure diagram of the toilet bidet in embodiment 1;

FIG. 2 is the total structure diagram of the base of the primary fixing seat, semicircular grooves and iron block in embodiment 1;

FIG. 3 is the total resolution graph of silicone hose and the base of the primary fixing seat, semicircular grooves, semi-circular iron block, round magnet and round sleeve in embodiment 1;

FIG. 4 is the overall structure diagram of the secondary fixing seat;

FIG. 5 is the three-dimensional structure diagram of toilet bidet in embodiment 2;

FIG. 6 is the structure diagram of the toilet bidet is use in embodiment 2;

FIG. 7 is the structure diagram of water spray device arranged on the secondary connecting plate in embodiment 2;

FIG. 8 is the three-dimensional structure diagram of water spray device in embodiment 2;

FIG. 9 is the explosion structure diagram of water spray device in embodiment 2;

FIG. 10 is the explosion structure diagram of water spray device from different angles in embodiment 2;

FIG. 11 is the structure diagram of toilet bidet arranged on toilet in embodiment 3;

FIG. 12 is the structure diagram of mounting block in embodiment 3;

FIG. 13 is the planar structure diagram of shell in embodiment 3;

FIG. 14 is the planar structure diagram of cover plate of embodiment 3;

FIG. 15 is the three-dimensional structure diagram of nozzle tube installed on mounting slice in embodiment 3;

FIG. 16 is the structure diagram of nozzle tube installed on mounting slice from the other angle in embodiment 3;

FIG. 17 is the structure diagram of nozzle tube installed on cover plate in embodiment 3;

FIG. 18 is the three-dimensional structure diagram of toilet bidet in embodiment 4;

FIG. 19 is the structure diagram of water spray device in embodiment 4;

FIG. 20 is the structure diagram of suction disc in embodiment 4;

FIG. 21 is the three-dimensional structure diagram of toilet bidet in embodiment 5;

FIG. 22 is the structure diagram of the primary fixing seat pasted in adhesive film in embodiment 5;

FIG. 23 is the structure diagram of sprayer arranged on mounting plate in embodiment 5;

FIG. 24 is the three-dimensional structure diagram of sprayer in embodiment 5;

FIG. 25 is the explosion diagram of sprayer in embodiment 5;

FIG. 26 is the explosion diagram of sprayer from the other angle in embodiment 5;

Symbols of major components are shown below:

### Embodiment 1

Toilet 10A; Silicone hose 20A; Water outlet pipe 202A; Sprayer 30A; Sprayer 30A; Water valve switch 40A; The primary fixing seat 50A; Base 501A; Semicircular grooves 502A; Semicircular iron block 503A; Round magnet 504A; Round sleeve 505A; Magnet placing slot 5051A; The secondary fixing seat 60A; Base 601A; clasp 602A; Water tank heating device 70A;

### Embodiment 2

Toilet stand 11B; the primary connecting plate 210B; the secondary connecting plate 210B; Side wall 221B; Water spray device 30CB; Mounting base 40B; Opening 401B; Inserted tube 402B; Nozzle 41B; Nozzle tube 411B; Rotor 412B; Sleeve 42B; Capping 43B; Silicone hose 50B; Adhesive film 60B;

### Embodiment 3

Mounting block 10C; Side wall 11C; Steps 12C; Mounting plate 20C; Shell 210C; Extension part 211C; Cover plate 220C; Holding tank 250C; Inserted tube 260C; Water spray device 30C; Mounting slice 310C; Through-hole 311C; Nozzle tube 320C; Outer tube 321C; Inner tube 322C; Water outlet hole 323C; Slope 324C; Shield ring 325C; Water supply pipe 40C; Controlling box 70C; Box 80C; Controller 90C; Flexible cord 91C;

### Embodiment 4

Toilet stand 10D; Seat cover 12D; Seat cushion 13D; Water spray device 20D; Mounting seat 21D; Nozzle 22D; Nozzle tube 230D; Control device 30D; the primary pressure regulating valve 310D; Cold water supply valve 311D; The secondary pressure regulating valve 320D; Hot water supply valve 321D; Water yield controller 330D; Water supply pipe 40D; Suction disc 50D; Clamping part 510D; Steel cap 60D;

### Embodiment 5

Mounting plate 10E; Side wall 110E; The secondary screw hole 120E; Sprayer 20E; Shell 210E; Inserted tube 220E; Opening 230E; Concave cavity 240E; Rotor 250E; Nozzle tube 260E; Sleeve 270E; Capping 280E; Silicone hose 30E; Water inlet pipe 310E; Water outlet pipe 320E; Water valve switch 40E; the primary fixing seat 50E; the primary screw hole 510E; Adhesive film 60E; The secondary fixing seat 70E; clasp 710E; Heating device 80E;

### DESCRIPTION OF THE PREFERRED EMBODIMENTS

For a clearer description, this invention is further described below based on accompanying drawings.

### Embodiment 1

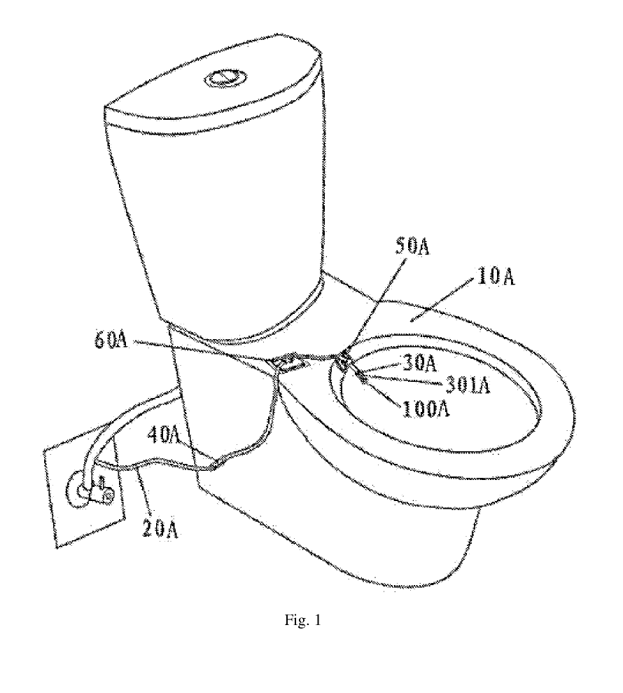

As shown in FIGS. 1-4, the toilet bidet supplied in this invention can be dismantled and mounted on toilet 10A, which can spray and wash their perineum of people who go to the toilet, so as to save toilet paper and be environment-friendly.

Specifically, this invention consists of silicone hose 20A, sprayer 30A, water valve switch 40A and the primary fixing seat 50A;

Water inlet end of silicone hose 20A is connected to tap water pipe, water outlet end is connected to sprayer 30A; water valve switch 40A is arranged on above silicone hose 20A to control water flow; the primary fixing seat 50A is arranged on rear end of the opening of toilet 10A and fixed onto the interior wall of the opening of toilet 10A; the junctions between water outlet end of silicone hose 20A and sprayer 30A can be movably clamped in the primary fixing seat 50A to make the water outlet end of silicone hose 20A adjustable in vertical direction; there are a sprayer 30A which inclines upwards to form a 45-degree angle in sprayer 30A; sprayer 30A is properly aligned with front upper end of opening of toilet 10A.

In this way, through simple mounting of corresponding silicone hose 20A, sprayer 30A and the primary fixing seat 50A, toilet bidet can be formed with less accessories, simple mounting, and easy to use. When using, the height of water outlet end of silicone hose 20A is adjustable in vertical direction, so does sprayer 30A. Furthermore, human perineum of people who go to the toilet can be washed, which can save toilet paper and is environment-friendly, particularly for children and the old with difficult mobility. This invention can be removed and used to rinse floor, sole and stubborn stains in toilet, which cannot be done by traditional toilet bidet, making this invention has strong practicality.

In further implementation, the primary fixing seat 50A is fixed on interior wall of the opening of toilet 10A through adhesive film.

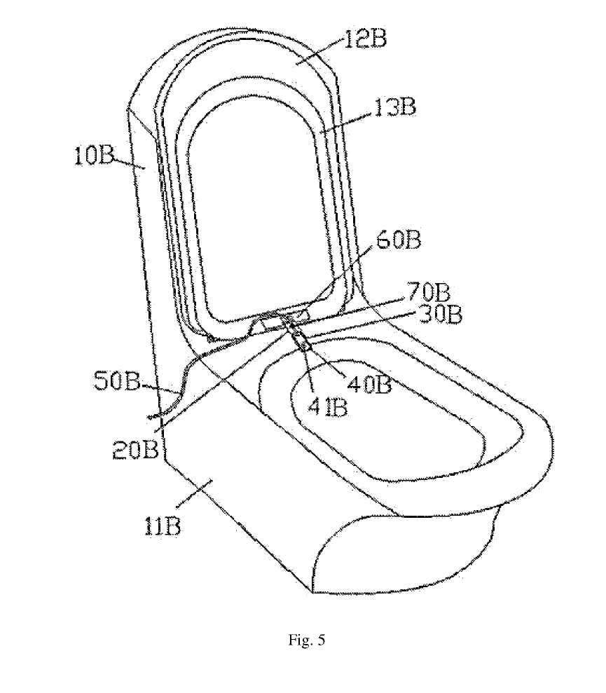

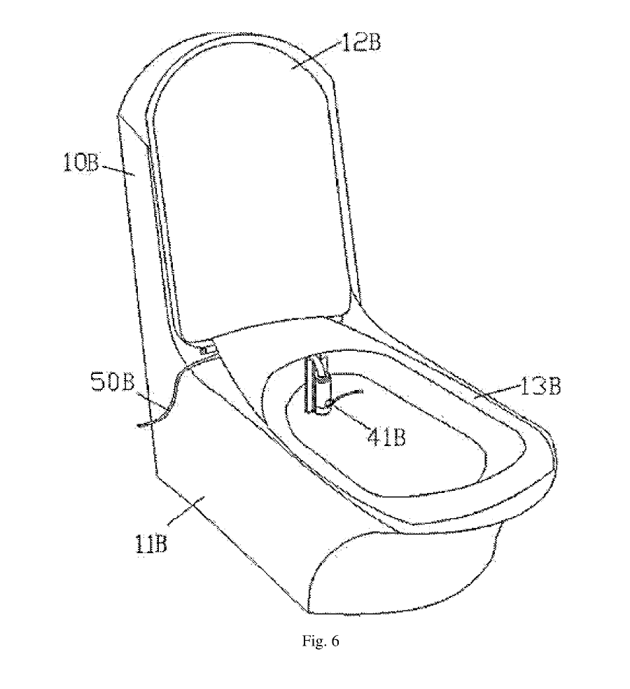

In the embodiment, compared with FIGS. 4 and 5, the primary fixing seat 50A consists of base seat 501A, semicircular grooves 502A, semicircular iron block 503A, round magnet 504A and round sleeve 505A with two layers inside and outside; there is magnet placing slot 5051A between round sleeve 505A with two layers inside and outside, round magnet 504A is fixed in magnet placing slot 5051A; Semicircular grooves 503 is arranged above base seat 501A and toilet opening is back to the base seat 501A, semicircular iron block 503A is fixed on semicircular grooves 502A through adhesive film; Round sleeve 505A can be movably arranged outside the silicone hose 20A;

When round sleeve 505A with round magnet 504A approaches to semicircular iron block 503A, semicircular iron block 503A and round magnet 504A attract to each other to make silicone hose 20A fix on the primary fixing seat 50A.

Thus, when it is necessary to remove silicone hose 20A to clean and disinfect or use it to rinse floor, sole, round sleeve 505A with fixed round magnet 504A is slightly removed to make the whole silicone hose 20A easily remove and silicone hose 20A is fixed through the way of semicircular iron block 503A attracting round magnet 504A; fixing device constituted by semicircular iron block 503A and round magnet 504A has long service life.

Of course, according to practical need, semicircular iron block 503A and round magnet 504A can be fixed with other lock catch and fasteners; there is no example herein.

Further, as the best scheme, this invention also consists of at least one the secondary fixing seat 60A for fixing silicone hose 20A, the secondary fixing seat 60A is arranged between water inlet end of silicone hose 20A and the primary fixing seat 50A, and the secondary fixing seat 60A is fixed to side end or upper front end of toilet 10A through adhesive film.

So, silicone hose 20A is towed to the primary fixing seat 50A along the outer wall of toilet 10A through the fix of the secondary fixing seat, to make the silicone hose 20A tidy and order.

In this embodiment, the secondary fixing seat 60A consists of base seat 601A and two clasps 602A arranged side-by-side on base seat 601A, two clasps 602A are arranged in opposite direction to make the opening end of two clasps 602A reverse.

Further, in implementation, silicone hose 20A is slightly clamped into two clasps 602A; when it is necessary to remove silicone hose 20A, corresponding silicone hose 20A is slightly pulled to make silicone hose remove and take easily.

In conclusion, the toilet bidet provided by this invention has fewer parts, is simple to install, and convenient to use. In addition, it provides conveniences to change the habits of going to bathroom of countrymen on a large scale, leads countrymen to enter into cleaning time, and showers private parts at any time. The practice shows that the installation of this invention only needs about 5 to 10 min. During installation, except moving the screw on the water inlet pipe, there is no need to change the original toilet overall framework, drill on the original toilet or move other screws and so on. What's more, this invention is equipped with water tank heating device 70A, and the corresponding water temperature regulator can be controlled through wireless control of the configured remote-controller 80 to adjust the water temperature of water inlet end of water outlet pipe 202A. Especially, when used in winter, water heating temperature of corresponding water temperature regulator can be adjusted to about 40□, which enables the water temperature from sprayer 30A to be suitable for the human body and the users will not feel cold.

In addition, this invention is equipped with air blast dryer. The corresponding wind outlet pipe is connected to water outlet pipe 202A as well. After the human perineum is cleaned by sprayer 30A, there is no remained water in water outlet pipe 202A and then start the air blast dryer. A certain heat of hot air can be transferred to sprayer 30A through wind outlet pipe and water outlet pipe 202A to conduct the drying process to human perineum. The corresponding hot air aligns to the cleaned part of human body, with high drying efficiency and high drying speed, to keep the human body comfortable and dry.

At the same time, the silicon hoses 20A of this invention can be disassembled and cleaned at any time to maintain clean sanitation. The height of sprayer 30A can be adjusted as well, which makes adaptability strong and is suitable for senior citizen, middle-aged people and children. Correspondingly, this invention can be dismantled to clean floors, soles and stubborn stains inside of toilet, which can't be done by the traditional toilet bidet and makes practical value of the present invention stronger.

### Embodiment 2

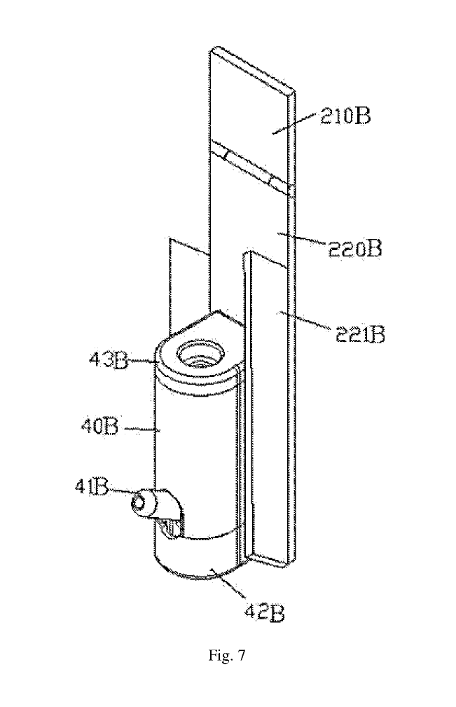

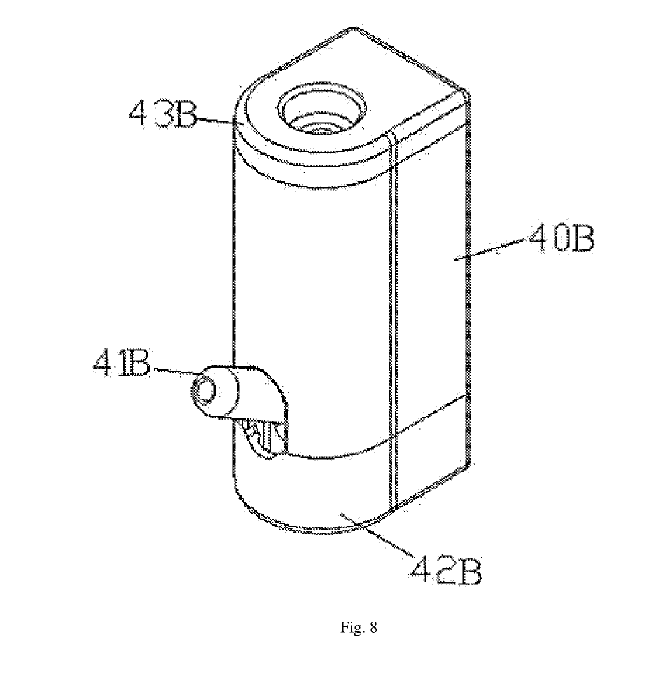

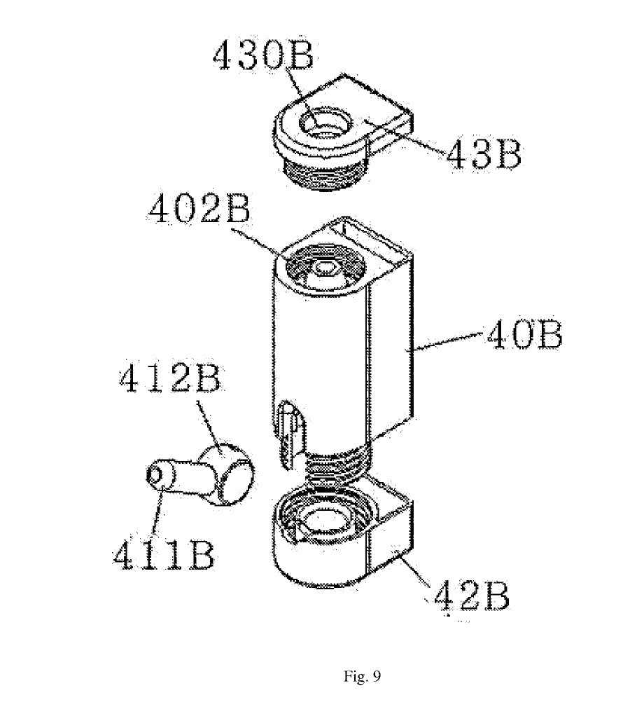

Further referring to FIGS. 5-10, a toilet bidet installed on toilet practices to clean the private parts of human body after going to the bathroom, comprising three parts: hoses connecting water, water spray devices, and fixing devices for fixing water spray devices. It also consists of the primary connecting plate 210B dismounted and connected at the bottom of toilet seat 11, the secondary connecting plate 220B jointed with the primary connecting plate 210B, water spray devices 30B arranged on the front of secondary connecting plate 220B, as well as silicon hoses 50B whose one end is connected to tap water pipe (not shown in the Figure) and the other end is connected to the water spray devices 30B, The back side of the secondary connecting plate 220B is tightly closed to the interior wall of toilet opening and in a vertical state when the toilet seat 11 is put down. Users can install completely by themselves, with the characteristics of a few integral components, low cost and being environment-friendly. It has wide adaptability, and is suitable for toilets with various shapes and different sizes. Silicon hoses 50B have favorable elastic performance, so it deforms easily. In this way, it is convenient for installation. Definitely, normal hoses can be adopted too, but silicon hoses are more convenient than normal hoses. The secondary connecting plate 220B rotates to vertical state and tightly closed to the interior wall of toilet opening under the action of its own gravity. There is no need to adjust the position by human, which is convenient to be used. The primary connecting plate 210B and the secondary connecting plate 220B could be set as rectangle or other shaped plate. Both volume and areas of the entire board are small, so that it saves more materials and space than the mounting components of the present bidet.

Specifically, the primary connecting plate 210B is fixed on the back of toilet seat 11 through a piece of adhesive film 60B. During installation, the air inside of adhesive film 60B needs to be drained, so it is fixed well. The process of installation just takes a few minutes, which is convenient for the users.

In an optimized embodiment of this invention, the primary connecting plate 210B and the secondary connecting plate 220B are set as magnetic attraction, either the primary connecting plate 210B or the secondary connecting plate 220B is magnetic plate and the other is magnetic material plate, for example, using stainless steel plate. After taking down the water spray devices 30B, the secondary connecting plate is attached by the primary connecting plate and closes upward. Better, the length of the secondary connecting plate 220B is set as resisting on the toilet seat 11 when the secondary connecting plate 220B is attached by the primary connecting plate 210B. At this moment, due to the inner shield of toilet seat 11, the secondary connecting plate 220B is blocked by the shield ring of toilet seat 11 from the primary connecting plate 210B. When you use it again, the secondary connecting plate 220B is needed to be pulled down as the level of the primary connecting plate. It is convenient to use.

Specifically, water spray devices 30B comprises mounting seat with one cavity 40B arranged on the secondary connecting plate, inserted tube 402B of connecting with silicon hoses fixing arranged on inside of the concave cavity of mounting seat, and a nozzle 41B arranged on mounting seat 40B connecting with inserted tube 402B. Water spray nozzle at the end tip of nozzle 41B can be set as circle or other shapes. Definitely, multiple water spray nozzles can be set as well.

Better, magnetic attraction exists between the primary connecting plate and the secondary connecting plate so that fixing devices for fixing water spray devices were formed by the primary connecting plate and the secondary connecting plate. Water spray devices arranged on the secondary connecting plate are fixed on the secondary connecting plate because of the magnetic effect. After using the toilet bidet, lift the toilet seat. The water spray devices can be disassembled easily to clean floor, sole and stubborn stains on the toilet. The installation and disassembly of the water spray devices are much easier than the existing toilet bidet, with fewer materials and lower costs. Specifically, the secondary connecting plate 220B can be set as magnetic material plate. The mounting seat 40B can be set as magnetic plate. Mounting seat 40B can be set as magnetic material plate. The secondary connecting plate 220B can be set as magnetic plate. The two plates are set as magnetic attraction in order to be convenient for disassembly, change and maintenance without other tools.

Preferably, in order to prevent water spray devices 30B from swinging and sliding under the effect of fluctuations of the water pressure, side wall 221B are arranged on both sides of the secondary connecting plate. Better, the side wall 221B is tightly closed to the water spray devices 30B to keep the water spray devices stable, as shown in FIG. 3. Definitely, it can be set as other protective components, such as, side by side convex set. In the case of the side wall 221B, a skid-proof side wall can be added to the bottom of the secondary connecting plate 220B to keep the water spray devices fixed on the secondary connecting plate 220B while using.

Specifically, nozzle 41B comprises nozzle tube 411B arranged inside of concave cavity, and rotor 412B integrated with tube 411B; rotor 412B is provided with limber hole connecting with the nozzle tube 411B towards the direction of inserted tube 402B; a concave cavity is provided inside of the cavity of mounting seat 40B; the opening 401B matching with nozzle tube 411B is arranged on the lower part of mounting seat 40B. Rotor 412B fits in the size of concave cavity. In other words, cross section of the concave cavity is a little bit larger than the cross section of cavity of mounting seat 40B. Nozzle tube 411B can move up and down along the front opening 401B. Better, arrange concave cavity as spherical bottom and smooth side wall for both sides. Rotor 412B is set to fit the size of concave cavity. Nozzle tube 411B can move up and down along the front opening 401B to enable the user to adjust the direction of water spraying. Definitely, the concave cavity can be arranged as spherical. The size of rotor 412B is set to fit the sphere of concave cavity. It is convenient to adjust the direction of nozzle 41B by using such universal joint structure.

Better, to conveniently maintain the cavity of mounting seat 40B and keep sediment or other debris from blocking the water supply channel, sleeve 42B can be arranged on the bottom threaded connection of mounting seat 40B. For the convenience of water supply channel plugging and fixed, a capping with thorough-hole 43B can be connected to the top of mounting seat 40B, as shown FIGS. 5 and 6. Thread is arranged inside of the upper of mounting seat 40B and the outside of the lower part.

Better, a drying device can be set on the upper opening inner wall of toilet stand 11B too. Control device (not shown in the Figure) for controlling open and close of drying device and water spray device 30B. After the water spray devices 30B spray water, drying device starts immediately. The overall operation is coherent and time-saving. Users don't need to clean by using toilet paper. On the one hand, the control device can be used as the switch of water spray device 30B and drying device. On the other hand, the control device can be used as the adjustment device of water power and drying speed. Definitely, a few gears can be arranged on the control device corresponding to different functions, so users can operate conveniently. A certain usage pattern of a user can be saved as well, so the same steps can be operated by using one key. Thus, it is very convenient to users. Definitely, control device for controlling drying device can be arranged as well. For instance, inductive switch can be set on either side of the side wall of base 11, so the user can control drying time by himself/herself.

Better, the primary connecting plate 210B is provided with screens 60 for clamping water supply pipe of water spray device 30B, to make it fix on one direction without random swing, and reduce effects brought by water pressure fluctuation, as shown in FIG. 1.

### Embodiment 3

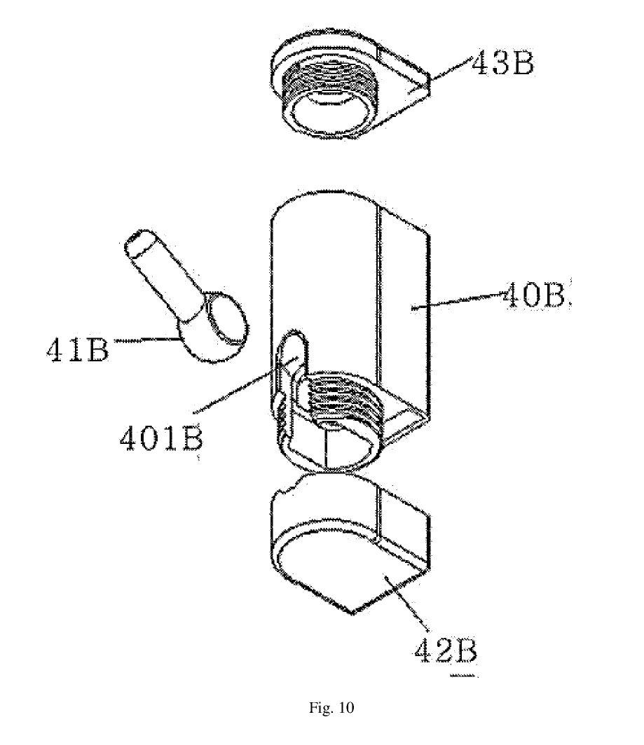

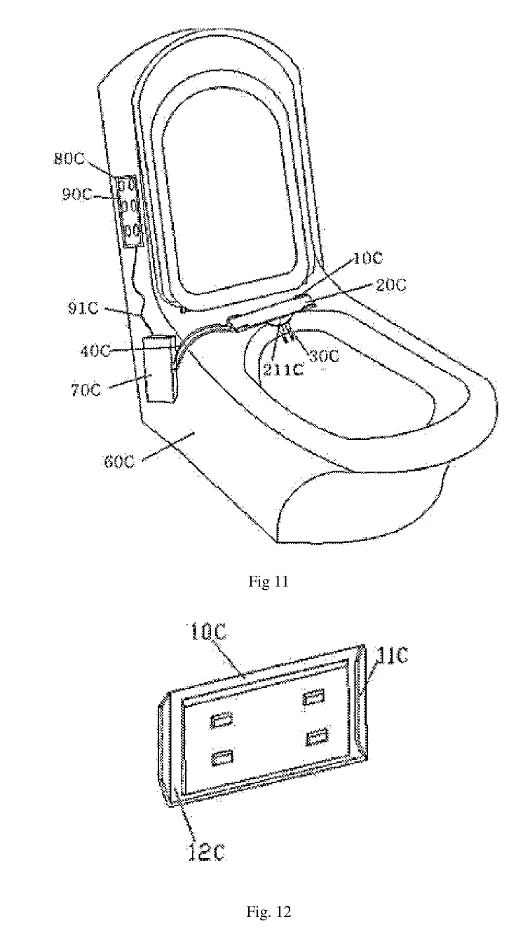

Further referring to FIGS. 11-12, toilet bidet of this invention is mounted in the toilet, to practice the function of cleaning lower body after toilet, including: 2 mounting blocks 10C which can be arranged on toilet stand 60 in disassembly and connection, and can be pasted with double-sided tape and fixed with fixing pieces; one mounting plate 20C which is clamped on 2 mounting blocks 10C in horizontal side-by-side setting, one water spray device 30C with at least one nozzle which is arranged on mounting plate 20C and close to interior wall of toilet opening; water supply pipe 40C whose one end is connected to tape water pipe and the other end is connected to water spray device 30C, specifically, hose, stainless steel hose or silicone hose can be used; mounting block 10C, mounting plate 20C and water spray device 30C can be made of plastic rubberized materials; the whole bidet has light weight; the appearance of mounting plate 20C can be but not limited to rectangular.

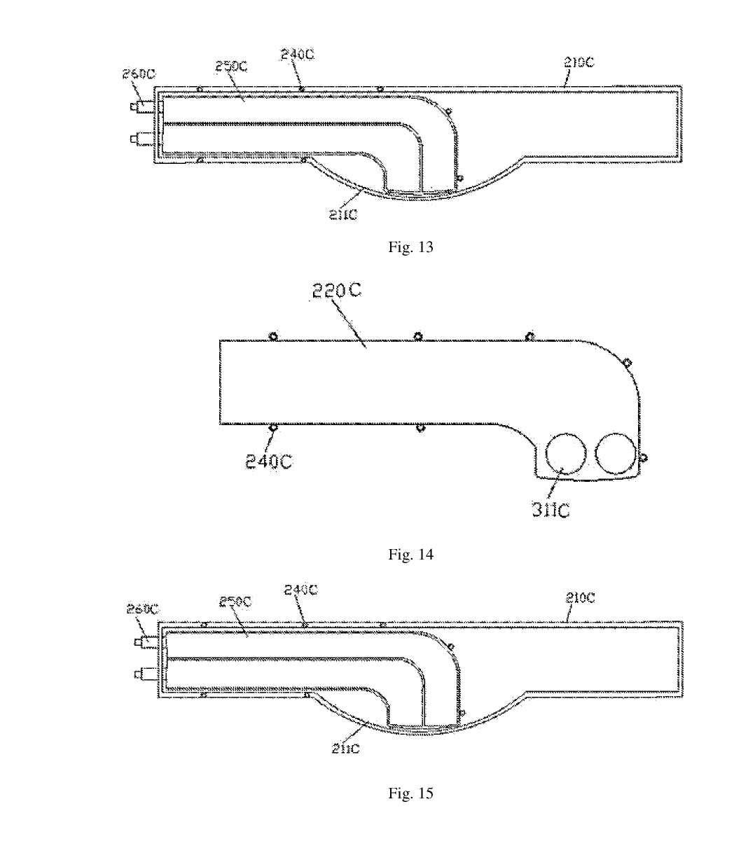

Specifically, as shown in FIG. 13, mounting plate 20C consists of one shell 210C with at least one holding tank 250C, cover plate 220C clamped on shell 210C, at least one inserted tube 260C arranged on one end of the shell 210C for connecting water inlet pipe; inserted tube 260C is connected to holding tank 250C, and sealed water channel is formed between holding tank 250C and cover plate 220C. The connection method between shell 210C and cover plate 220C can be that: several fixing holes 240 are arranged on corresponding position of periphery of shell 210C and cover plate 220C which are fixed with screws. Certainly, shell 210C and cover plate 220C can be clamped with card slot and prominent structure; preferably, 2 inserted tubes 260C and 2 holding tanks 250C are arranged and connected, as shown in FIG. 3, the cross section of holding tank 250C has better to be arc and also can be other forms.

Both sides of mounting block 10C is provided with side wall 11C for clamping mounting plate 20C, as shown in FIG. 4, and the bottom of 2 side walls 11C is provided with one step 12C; when the shell 210C is mounted on mounting block 10C, cover plate 220C will not touch the toilet.

Specifically, as shown in FIGS. 13 and 15, long side of shell 210C is provided with one extension part 211C for mounting water spray device 30C in horizontal extension; holding tank 250C is arranged to extension part 211C in extension; in installation, lateral long side of shell 210C approximately aligns at the edge of toilet opening, as shown in FIG. 1; better, extension pat 211C is set as arc without corner angle, and is safe. The appearance is also beautiful and materials also can be saved.

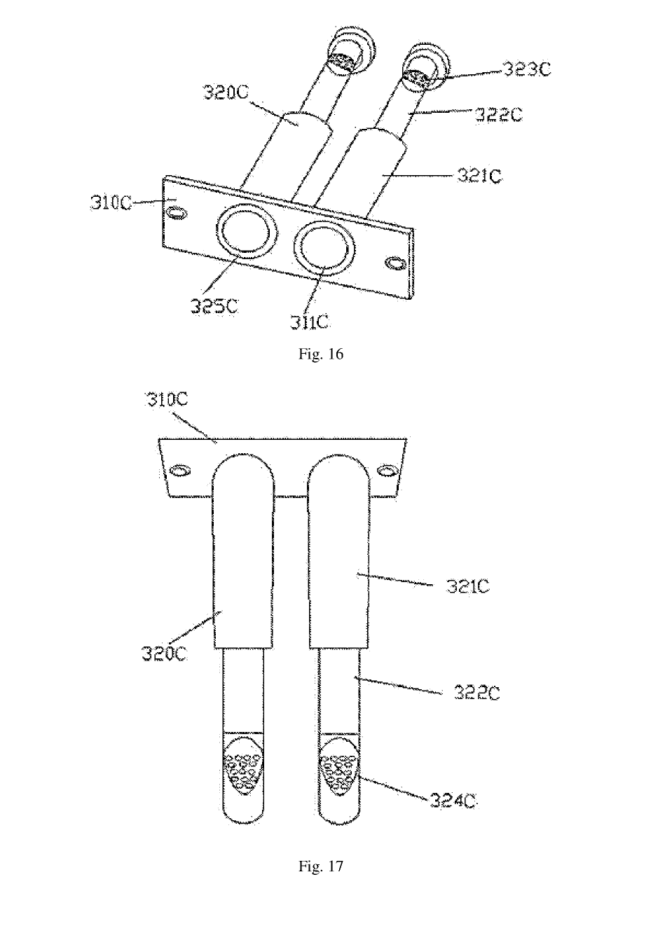

Preferably, as shown in FIGS. 16 and 17, water spray device 30C consists of one mounting plate 310C. 2 through-holes 311C are arranged in horizontal side-by-side and match with through-hole 311C, and pass through 2 nozzle tubes of 2 through-holes 311C respectively; the top of nozzle tube 320C is provided with shield ring 325C, to hold nozzle tube 320C on mounting plate 310C; the bottom is equipped with water outlet hole 323C; preferably, through-hole 311C can be set as circle, nozzle tube 320C is set as circle, and water outlet hole 323C is set as circle or oval; water sprays from water outlet hole 323C in use.

Specifically, nozzle tube 320C consists of outer tube 321C with shield ring 325C at the top, inner tube 322C covered in outer tube 321C and moving up and down in outer tube 321C; bottom of outer tube 321C and top of inner tube 322C are provided with resistance part for preventing inner tube 322C from falling off; reset spring is covered outside inner tube 322C (not shown in the Figure); both ends of reset spring are resistant to resistance parts of outer tube 321C and inner tube 322C; inner tube 322C stretches from outer tube 321C under water pressure in use; while at the end of water spraying, inner tube 322C retracts in outer tube 321C under tension of reset spring, which is simple to use.

Preferably, lower section of water spray device 30C is equipped with one slope 324C, water outlet hole 323C is set on slope 324C, and faces upward; specifically, several water outlet holes 323C can be set side-by-side, and the slope 324C is set as fan shape with uniform water spraying.

In addition, one drying device can be arranged on side wall of toilet opening (not shown in the Figure), and used with water spray device 30C together; after use of water spray device 30C, drying device starts immediately, with continuous operation and without manually starting, which is very convenient.

The bidet also consists of suction disc on one side wall of both sides of toilet tank, hook on suction disc, one box 80C hanged on hook, controller 90C inbuilt in box 80C and connected to water spray device 30 through flexible cord 91C for controlling water temperature, water pressure and drying device; specifically, one control box 70C for controlling heating and circuit is arranged on proper position of the toilet, and connected to controller and also to water supply pipe 40D. The user can take out controller 90C from box 80C to regulate and control water temperature, water pressure and drying device, which is very convenient.

### Embodiment 4

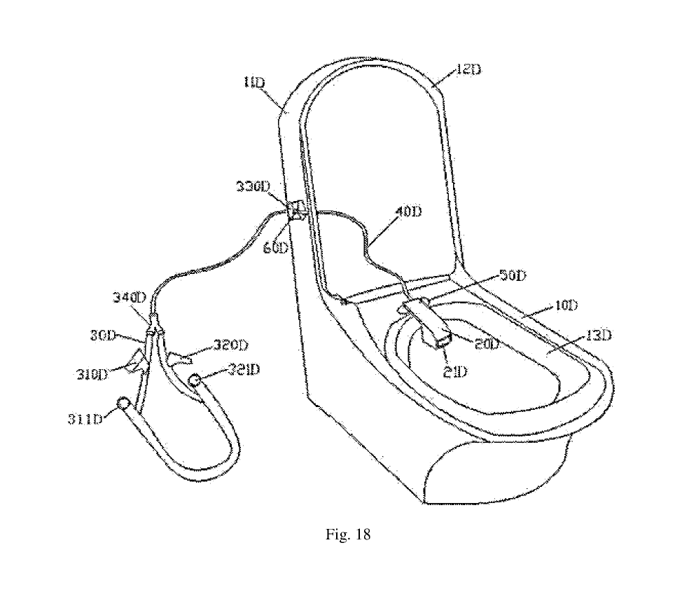

As shown in FIG. 18, toilet bidet of this invention consists of water spray device 20D arranged on the bottom of back of toilet stand 13D through suction disc 50D, water supply pipe 40D connected to water spray device 20D and control device 30D connected with water supply pipe 40D and used to control water temperature and water-yield capacity. Water spray device 20D is absorbed on the back of toilet stand 10D or toilet seat 13D by absorbing with adhesive suction disc 50D. This way is not only convenient to install but will not damage the parts of original toilet, which saves resources, and is very environment-friendly. It can be installed on toilets with different styles and sizes, and has extensive applicability compared with existing bidet device. FIG. 18 is the diagram of arranged on back and bottom of toilet seat. there are space to contain bidet between toilet seat 13D and seat cover 12D, without occupying extra space; when using, put down toilet seat 13D, water spray device 20D of bidet is just located in the opening of toilet stand 10D, which is convenient; certainly, the suction disc can be directly installed in toilet stand 10D.

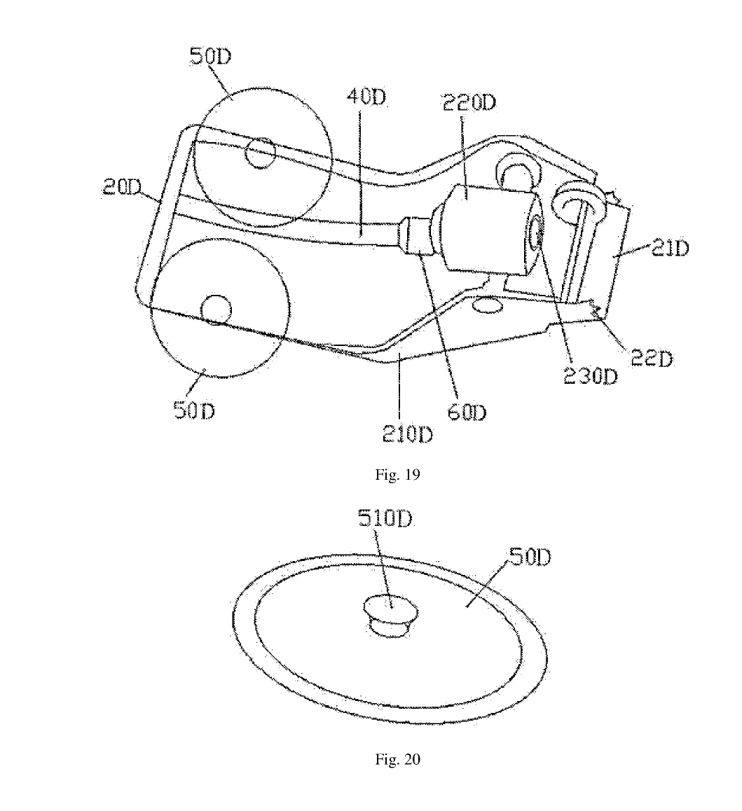

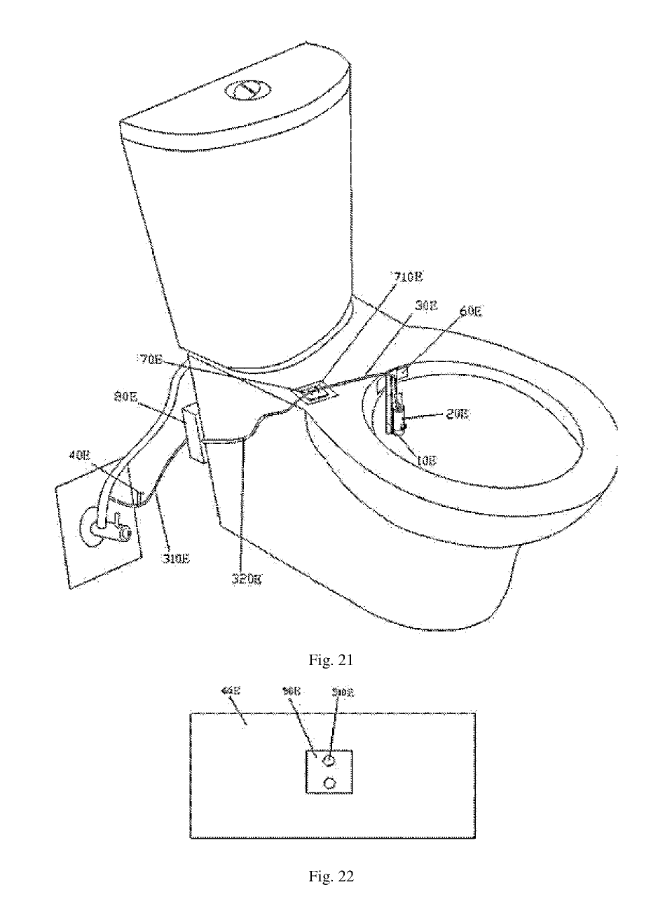

Specifically, as shown in FIGS. 18 and 19, water spray device 20D consists of nozzle 22D, mounting seat 21D fixed on toilet stand 10D and used to install mounting nozzle 22D, at least one suction disc 50D which constitutes a whole with mounting seat 21D and is located in the bottom of mounting seat 21D, suction disc 50D is the disc shown in FIG. 20 and it is made of transparent soft elastic materials and also other soft materials; suction disc 50D is mounted and fixed on the base to fix mounting seat 21D; the location is adjusted well in installing, to make water spray device 20D located in the opening of toilet stand 10D. Better, flexible sprayer can be used for nozzle 22D, which can extend sprayer automatically and retracts automatically after the completion of water spraying, so it is not susceptible to external contamination when idled.

Certainly, another structure can be used, as shown in FIGS. 18 and 20; suction disc 50D and mounting seat 21D are separate before installation; there is a prominent connecting part 510D on top of suction disc 50D, i.e., the appearance raises like mushroom; mounting base 21D is provided with clip matching with connecting part 510D. Preferably, 2 suction discs 50D are arranged at the bottom of the back of toilet seat 13D; correspondingly, 2 bayonets are arranged symmetrically on both sides of mounting seat 21D; installation operation of water spray device 20D is very easy and fast.

Specifically, as shown in FIG. 18, control device 30D consists of the primary pressure control valve 310D arranged on side of toilet and used to adjust cold water and the secondary pressure control valve 320D used to hot water and water yield controller 330D arranged above toilet tank 11 and connected to water supply pipe 40D to control mixed water inlet yield, the primary pressure regulating valve 310D is connected to cold water supply interface, the secondary pressure regulating valve 320D is connected with hot water supply interface, as shown in FIG. 1; there are cold water supply valve 311D and hot water supply valve 321D on the side. The user can adjust appropriately water temperature and yield according to practical need. The bidet is widely used among applicable users in which the old and children can learn easily and operate independently and it also applies to pregnant woman.

Specifically, the primary pressure regulating valve 310D and the secondary pressure regulating valve 320D are respectively connected to the water inlet holes. The inlet hole of Y-shaped tee is connected to the water yield controller 330D. The pipe may be made of the stainless hose, the both ends of which can be fixed by nuts. Better, the angle of the water inlet ends of Y-shaped tee can be designed to be acute angle.

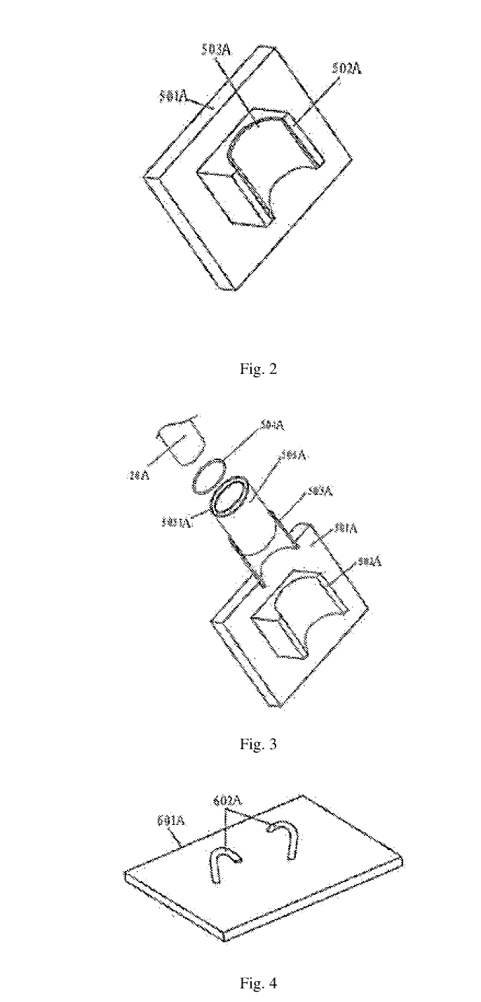

Specifically, nozzle 22D consists of a tubular shell installed on the mounting seat 21D, a nozzle tube 230D moving up and down in the shell and matching with the shell and a spring mounted outside the nozzle tube 230D. The resistance part (not shown in the Figure) is installed on the bottom of the inner wall of the shell and the top of the outer wall of the nozzle tube 230D. The resistance part can be but not limited to resistance ring. Both ends of the spring resist respectively on the resistance part of the shell and nozzle tube 230D. The original statue of the spring is compressed position. The nozzle holes are arranged on the lower section of the nozzle tube 230D and many nozzle holes are allowed. When using the bidet, the nozzle tube 230D in the shell may be pushed out due to the water pressure. When the bidet is turned off, the nozzle tube 230D will be pushed to the top of the shell due to the elastic force of springs, so as to achieve automatic extension of nozzle tube 230D, as shown in the FIG. 2.

Better, an opening is arranged on the mounting seat 21D in corresponding position at the bottom of the nozzle tube 230D in order to prevent the nozzle tube 230D from being polluted at idle. The top of the opening is provided with a rotatable baffle 21 for protecting nozzle tube 230D and a reset mechanism 22 for resetting the baffle 21 to the opening, as shown in FIG. 3. The reset mechanism 22 may be fastener structure or the spring with elastic expansion. When the nozzle tube 230D stretches out from the opening, the nozzle tube 230D will prop baffle 21 up and baffle 21 shall rotate along the opening of the mounting seat 21D. When the nozzle tube 230D retracts, the baffle 21 shall be pulled back by the reset mechanism 22 and the opening of mounting seat 21D shall be closed to protect the nozzle tube 230D from contamination, which is safe and convenient.

Better, water supply pipes 40D are connected to the water yield controller 330D by the steel cap 60D. The water supply pipe 40D may be made of hose, which is convenient for the installation. The water supply pipe 40D and water spray device 20D can be connected by steel cap 60D, which is safe and reliable.

The toilet bidet provided by this invention adopts suction disc to fix the water spray device onto the toilet, which is convenient for installing, dismantling and replacing components without using other tools. The installation of the bidet may be finished without dismantling any components of the toilet, which contributes to saving resources and protecting environment. In addition, the cost of components is low. Besides, the control device for controlling water temperature, water pressure and water yield is installed; and users including the old people and children can learn the operation easily, so it enhances the users' experience with more humanization. The water spray device adopts the automatic telescopic pipe tube, which is convenient to use. The water spray device is equipped with the baffle for protecting nozzle tube, which contributes to preventing it from being polluted at idle. The components cost less and can be replaced easily without professionals. The operation of the bidet is characterized in low power consumption and power efficient.

### Embodiment 5

As shown in FIG. 21, the toilet bidet provided by this invention is installed on the toilet, which consists of a mounting plate 10E; the mounting plate 10E can be dismantled and is installed on the interior wall of toilet opening next to the water tank of toilet. The sprayer 20E; the sprayer 20E is installed on the front of the mounting plate 10E and sprayer 20E and the mounting plate 10E have magnetic attraction. The water spray nozzle of sprayer 20E faces upward; silicone hose 30E; the inlet water end of silicone hose 30E is connected to the tap water pipe and the outlet water end is connected to the sprayer 20E; the water valve switch 40E; the water valve switch 40E is installed on the silicone hose 30E to control the water flow.

Specifically, the mounting plate 10E can be made of magnetic material plates, for example, the bottom of sprayer 20E can be set as magnet by adopting stainless steel sheet; the mounting plate 10E also can be set as magnet while the sprayer 20E is made of stainless steel sheet. Magnetic attraction between the sprayer 20E and the mounting plate 10E makes sprayer 20E take down from mounting plate 10E at any time to wash the floor and soles, vegetables and the stubborn stains in the toilet, which is impossible for the traditional toilet bidet, to make this invention have high practicality. Because the silicone hose 30E has elastic property, and can deform, and is installed easily, it is easier installation than general hose.

More specifically, as shown in the FIG. 21, the mounting plate 10E can be fixed on the inner wall of the toilet opening. Because the air in the adhesive film 60E is pressed out and the negative pressure is formed, the mounting plate 10E is fixed on the adhesive film 60E steadily. In addition, the method adopting the adhesive film 60E has the advantages of occupying small space, saving material, low cost and environment protection.

An embodiment of this invention is shown in FIG. 22. The adhesive film 60E is fixed on the primary fixing seat 50E and the mounting plate 10E is arranged on the primary fixing seat 50E. More preferably, the two primary screw holes 510E are arranged on the primary fixing seat 50E and many secondary screw holes 120E are arranged on mounting plate 10E side by side. The mounting plate 10E can be connected by crossing the primary screw hole 510E and the secondary screw hole 120E. Many secondary screw holes 120E are arranged on the mounting plate 10E and the height of the nozzle tube 260E can be adjusted in accordance with requirements, which makes the applicability of bidet more extensive.

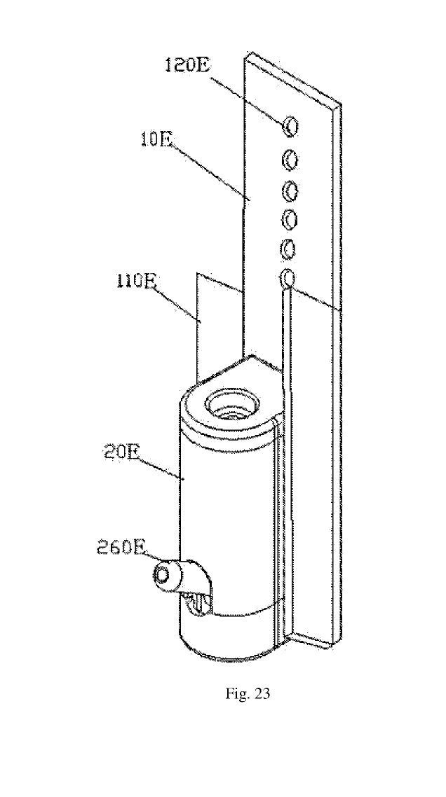

More beneficially, as shown in FIG. 23, the side wall 110E avoiding moving right and left can be installed on the both sides of the front of the mounting plate 10E. Generally, the fluctuation of water pressure shall make the sprayer 20E wobble right and left, which is inconvenient for the users. The installation of side wall 110E on the mounting plate shall prevent the sprayer 20E from waggle.

Further, as shown in FIG. 21, the toilet bidet also consists of secondary fixing seat 70E fixed on the side end face or the top end face of the toilet. At least a clasp 710E for fixing silicone hose 30E is arranged on the secondary fixing seat 70E. Preferably, the buckling direction of the two clasps 710E is opposite, which can enhance its stability.

Specifically, the silicone hose 30E consists of water inlet pipe 310E and water outlet pipe 320E. A heating device is installed on the junction between the water inlet pipe 310E and the water outlet pipe 320E. The remote control connecting to the heating device 80E by wireless is hanged on the side wall of the toilet tank (not shown in the Figure) to control the water temperature and heating device 80E, so that the temperature can be adjusted to a certain number for convenience. More specifically, a suction disk can be installed on the inner wall of the toilet tank. A box for placing the remote control is connected to the suction disk in order to provide convenience for the user which makes this invention more humanized.

Preferably, the heating device 80E can be fixed on the toilet lid or the wall by the suction disk and its appearance is like a box. A hook is arranged on the suction disk and the box is hanged up on the hook. The box is installed on the gap between the toilet lid and the wall. Therefore, the heating device 80E can hide at the back of the toilet, which shall not occupy the space and not influence the overall sense. A dryer connected to the water outlet pipe can be installed in the heating device (not shown in the Figure). The dryer is connected to the remote control by wireless to regulate the volume and temperature of exist wind. When the perineum is cleaned by the sprayer 20E, the dryer shall be on to transmit warm wind by water outlet pipe 320E to the sprayer 20E, so as to dry the perineum. The warm hot blows to the place cleaned and the drying is efficient, which make the human keep comfortable. Besides, it is convenient to use.

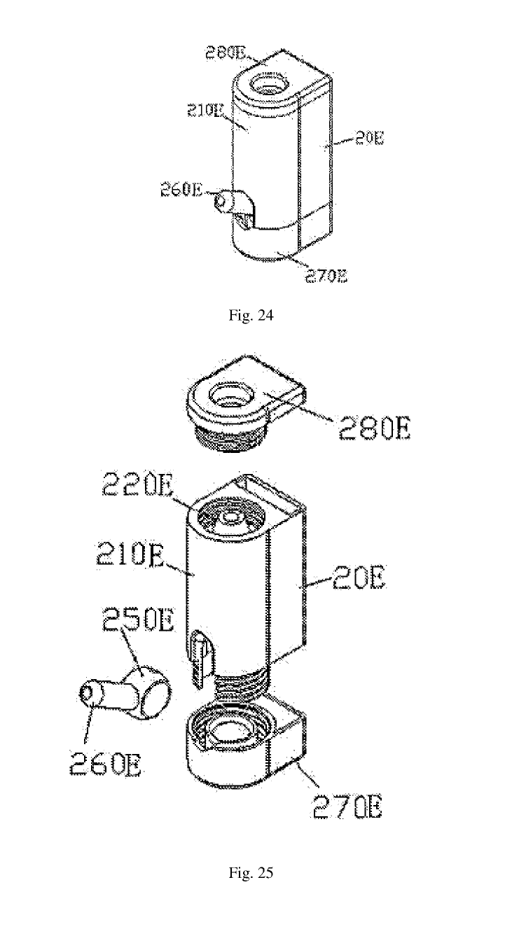

More specifically, as shown in the FIGS. 24 to 26, the sprayer 20E consists of a shell 210E, a rotor 250E and a nozzle tube 260E. Shell 210E consists of a cavity. The water inlet hole is arranged on the top of shell 210E while the top is sealed. The inserted tube 220E for connecting to the silicon hose 30E is installed on the cavity. The opening 230E is arranged vertically on the front of the lower section of the shell 210E; a concave cavity 240E is arranged on the top of opening 230E of the cavity. A rotor 250E is installed on the concave cavity 240E and matches with the concave cavity 240E. A limber hole is arranged on the rotor 250E towards the direction of the inserted tube 220E. The nozzle tube 260E and rotor 250E constitute a whole. Nozzle tube 260E is connected to the limber hole and the nozzle tube 260E can move up and down along the opening 230E. Better, the bottom of concave cavity 240E is designed as the sphere on the bottom and the two side walls are designed to be smooth interior walls. The rotor 250E is designed to match with the concave cavity 240E. Nozzle tube 260E can rotate up and down along the opening 230E of the shell 210E in order to be convenient for users to adjust the direction of the spraying. Absolutely, the concave cavity 240E also can be designed as sphere and the rotor 250E is designed as sphere matching with the concave cavity 240E. Adopting universal joint structure is beneficial for adjusting the direction of nozzle tube 260E.

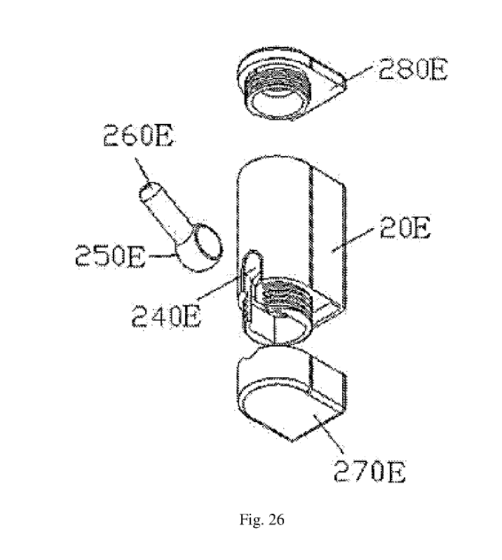

Preferably, a sleeve 270E is arranged on the bottom threaded connection of shell 210E in order to maintain the concave cavity of the shell 210E conveniently and prevent the water supply channel from blocking with sediment or other debris. There is capping 280E with through-holes in the upper section threaded connection of the shell 210E. The silicon hose is connected to the inserted tube 220E through the through-hole, as shown in FIGS. 25 and 26. The outer thread is arranged on the outer wall of the bottom of the shell 210E. The inner thread matched with the outer thread is arranged on the sleeve 270E. The inner thread is arranged on the inner wall of the upper section of the cavity of the shell 210E. The matched outer thread is arranged on the outer wall of the capping 280E.

The above embodiments disclosed are only a few of specific embodiments in this invention, but this invention is not limited to that. Changes thought by any technical personnel in this field shall be included in this invention.

1. A kind of toilet bidet is characterized in that: it consists of the water spray device having a body cleaning function, fixing devices for fixing the water spray devices, and silicone hoses for providing a water flow, wherein water inlet ends of the silicone hoses are connected to a tap water pipe, and water outlet ends thereof are connected to the water spray devices; the fixing devices are arranged on the rear end of an opening of the toilet and fixed on the inner wall of the opening of the toilet; the junctions between water outlet ends of the silicone hoses and the water spray devices are movably clamped inside the fixing devices, so that the height of the water outlet ends of the silicone hoses in the vertical direction can be adjusted; water spray device is provided with at least a nozzle which inclines upwards to form a 45-degree angle, and the nozzle is properly aligned with the front upper end of the opening of the toilet.

2. The toilet bidet described in claim 1 is characterized in that: the nozzle consists of a shell, a rotor and a nozzle tube. The shell consists of a cavity where an inserted tube is fixed for inserting into the silicone hose. An opening is installed longitudinally in the front of the lower section of the shell. A concave cavity is installed on the top of the opening of the cavity; a rotor is installed in the concave cavity and matches with the concave cavity. A limber hole is arranged towards the direction of the inserted tube in the rotor; a nozzle and the rotor constitute an organic whole. The nozzle tube is connected to the limber hole and can rotate up and down along the opening.

3. The toilet bidet described in claim 1 is characterized in that: the nozzle consists of a tube-like shell installed in the mounting base; the nozzle tube fixed on the shell and moving up and down in the shell is sheathed on the spring outside of the nozzle tube; the resistance part is installed in the inner wall of the shell and the top part of the outer wall of nozzle tube; the two ends of the spring are on the resistance part of the shell and nozzle tube; the water spray nozzles are arranged on the lower section the nozzle tube.

4. The toilet bidet described in claim 1 is characterized in that: fixing devices consists of the base, the semicircular groove, the semicircular iron block, the round magnet and a round sleeve with both inside and outside layers; the magnet placing slot is installed in middle of inside and outside layers of the round sleeve; the round magnet is fixed on the magnet placing slot; the semicircular groove is installed on the base and the opening is opposite to the base. The semicircular iron block is fixed on the semicircular groove by adhesive film; the round sleeve is sheathed on the silicone hose; when the round sleeve fixed with the round magnet approaches to the semicircular iron block, the semicircular iron block attracts the round magnet to make the silicone hose fixed on the fixing devices.

5. The toilet bidet described in claim 4 is characterized in that: the bidet consists of at least a fixing seat for fixing the silicone hose. The secondary fixing seat is installed in the middle of the water inlet end and fixing devices. The secondary fixing seat is fixed on the side end face and top end face by adhesive film; the secondary fixing seat consists of the base and two clasps on the end face of the base and the two clasps are installed in a reversed direction to make the openings of the two clasps in the opposite direction.

6. The toilet bidet described in claim 1 is characterized in that: the fixing devise consists of the primary connecting plate and the secondary connecting plate. The primary connecting plate is fixed on the bottom part of the toilet seat by adhesive film. The secondary connecting plate is in upright position when the toilet seat is put down. The primary connecting plate is articulated with the secondary connecting plate. The water jet and silicone hose are fixed on the secondary connecting plate. The water spray device also consists of the mounting base and the nozzle is fixed on the mounting base. The mounting base attracts the secondary connecting plate.

7. The toilet bidet described in claim 1 is characterized in that: the fixed devise consists of two mounting blocks and a mounting plate clamped in the mounting block; the mounting plate consists of a shell with at least one holding tank, cover plate clamped on the shell, and at least a inserted tube installed on one end of the shell to insert into water inlet pipe. The inserted tube is connected to the holding tank; the extension part for mounting water spray device is arranged in long side of the mounting block in horizontal extension; the holding tank is arranged in the extension part and the side wall for clamping mounting plate is installed in both sides of the mounting block.

8. The toilet bidet described in claim 1 is characterized in that: the silicone hose consists of water inlet pipe and water outlet tube. The water inlet end of the water inlet pipe is connected to the tap water pipe and the water outlet end is connected to the water tank heating device with water temperature regulator. The water outlet end of water tank heating device is connected to the water inlet end of the water outlet pipe. The water outlet end of the water outlet pipe is connected to the sprayer; Water temperature regulator consists of a microprocessor and wireless transceiver module connected to the microprocessor signal. Wireless transceiver module is connected to the remote control for regulating and controlling the water temperature regulator by wireless.

9. The toilet bidet described in claim 8 is characterized in that: the bidet also consists of the control device for controlling water temperature and water-yield capacity. The control device consists of the primary pressure regulating valve installed on the side of the toilet for regulating the cold water and the secondary pressure regulating valve for regulating the warm water as well as the water yield controller installed on the water tank of the toilet and connected to the water inlet end of the silicone hose for controlling the water inlet capacity. The primary pressure regulating valve and the secondary pressure regulating valve are connected to the inlet hole of Y-shaped tee. The outlet hole of Y-shaped tee is connected to the water yield controller. The primary pressure regulating valve is connected to the tap water pipe and the secondary pressure regulating valve is connected to the water outlet end of water tank heating device.

10. The toilet bidet described in claim 9 is characterized in that: the bidet also consists of an air blast dryer. The air blast dryer is arranged inside the water tank device and it is connected to an air outlet. The air outlet is connected to the water outlet pipe. The exterior surface of air blast dryer is provided with wind-heat adjusting key for regulating wind-heat.
